(19) United States
(12) Patent Application Publication
(10) Pub. No.: US 2006/0020979 A1
(43) Pub. Date: Jan. 26, 2006

(54) TV SIGNAL PROCESSING MODULE HAVING A MULTIPLE-DECK MINIPCI SOCKETS

(76) Inventors: Chia-Hsien Lee, Taipei Hsien (TW); Ming-Hsien Lin, Taipei Hsien (TW); Chao-Chin Liu, Taipei Hsien (TW); Yu-Sheng Weng, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 10/904,739

(22) Filed: Nov. 24, 2004

(30) Foreign Application Priority Data
Jul. 23, 2004 (TW) 093122121

(51) Int. Cl. H04N 7/173; H04N 7/18; H04N 7/16

(52) U.S. Cl. 725/80; 725/100; 725/131; 725/151

(57) ABSTRACT

A TV signal processing module includes a TV module, an internal transformer, and an external cable. The TV module is used for processing a TV signal. The internal transformer connected to the TV module is used for delivering the TV signal to the TV module. The internal transformer includes a high-voltage blocker for blocking a high-voltage signal to be applied to the TV module. The external cable, one end of which is connected to a TV cable and the other end of which is connected to the internal transformer, is used for sending the TV signal from the TV cable to the internal transformer.

### BACKGROUND OF INVENTION

1. Field of the Invention

The invention relates to a TV signal processing module, and more particularly, to a TV signal processing module comprising a multiple-deck MiniPCI socket.

2. Description of the Prior Art

In recent years, video media have played an important role in people's recreational lives. TV programs, for example, take people's pressures away and give people more happiness. Therefore, quality and convenience of video media have become a goal of today's technology industry.

Microsoft® provides a lot of video software for promoting the quality of a household digital video system, and furthermore, makes consumers feel more comfortable and entertained. These new software packages are mainly used in a DVD player, a digital TV displaying device, an audio playing device, or other displaying media. Surely, in order to cooperate with the promotion of software, a hardware platform is disclosed by many personnel computer producers or video hardware producers to achieve the promotion of the whole video system through cooperation between the hardware and the software.

Nowadays, a laptop (notebook) is frequently used because of its small size. Therefore, the laptop has to be compatible with many video media, just like the personnel computer. For example, the laptop can be used to receive a TV signal for viewers to watch TV, which has become a necessary function now. But in today's market, because the TV module of the laptop has a bigger size, about the size of a floppy-disk module or a DVD playing module, the floppy-disk module or a DVD playing module has to be moved out of the laptop to integrate the TV module and the laptop. However, although the above-mentioned method can achieve the function of watching TV on the laptop, it causes great inconvenience to users. For example, because the DVD playing module and the TV module cannot be positioned in the laptop at the same time, users cannot utilize the DVD playing module to record a TV program when watching TV through the TV module.

In the prior art, in order to solve the aforementioned problem, the computer producers disclose an external TV module. That is, the external TV module is electrically connected to a laptop through a USB 2.0 port. But, because the TV module is not built-in to the laptop, users have to carry a TV module. Therefore, this not only causes inconvenience to the users, but also has the disadvantage of complex electrical connections. So the external TV module does not conform to the demands of modern integrated laptops.

### SUMMARY OF INVENTION

It is therefore one of the objectives of the claimed invention to provide a TV signal processing device comprising a multiple-deck MiniPCI socket, to solve the above-mentioned problem.

According to an exemplary embodiment of the claimed invention, a multiple-deck MiniPCI socket for positioning at least one MiniPCI card is disclosed, the multiple deck MiniPCI socket comprises a plurality of MiniPCI sockets arranged in decks, wherein each socket comprises a plurality of plugs or pins.

Furthermore, a TV signal processing module is disclosed. The TV signal processing module comprises a TV module for processing TV signals; an internal transformer electrically connected to the TV module for transferring the TV signals to the TV module, the internal transformer comprising a high-voltage blocker for preventing a high-voltage from entering the TV module; and an external cable for transferring the TV signals from a TV cable to the internal transformer; wherein one end of the external cable is electrically connected to the TV cable and the other end of the external cable is electrically connected to the internal transformer.

In addition, another TV signal processing module is disclosed. The TV signal processing module comprises a multiple-deck MiniPCI socket for positioning the TV module. The multiple-deck MiniPCI socket comprises a plurality of MiniPCI sockets arranged in decks, each socket comprising a plurality of plugs or pins, wherein the TV module is plugged in one of the MiniPCI sockets of the multiple-deck MiniPCI socket.

Additionally, a method for transferring a TV signal to a TV module is disclosed. The method comprises providing an external cable; electrically connecting one end of an internal transformer to the external cable; electrically connecting the other end of the internal transformer to the TV module; electrically connecting a TV cable to the external cable; utilizing the external cable to receive the TV signal from the TV cable; utilizing the internal transformer to receive the TV signal from the external cable; utilizing the internal transformer to filter out high voltage signals from the TV signal; and utilizing the TV module to receive the filtered high voltage TV signals.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a multiple-deck MiniPCI socket of an embodiment according to the present invention.

FIG. 2 is a sectional diagram of the multiple-deck MiniPCI socket shown in FIG. 1 through the line 2-2′.

FIG. 3 is a diagram of a multiple-deck MiniPCI socket of another embodiment according to the present invention.

FIG. 4 is a diagram of a TV signal receiving interface of an embodiment according to the present invention.

FIG. 5 is a diagram of a TV signal processing module of an embodiment according to the present invention.

FIG. 6 is a diagram of a TV signal processing module of another embodiment according to the present invention.

FIG. 7 is a diagram of a method for transferring a TV signal to a TV module of the multiple-deck MiniPCI socket of an embodiment according to the present invention.

### DETAILED DESCRIPTION

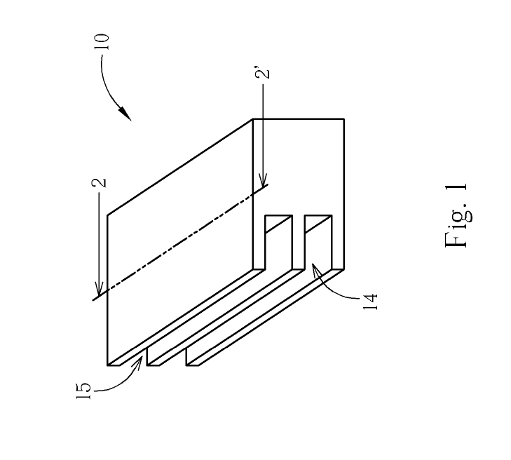

Please refer to FIG. 1, which is a diagram of a multiple-deck MiniPCI socket of an embodiment according to the present invention. Many of today's laptops contain a MiniPCI socket for positioning a wireless LAN module. The MiniPCI socket is a standard interface which occupies only a small space. Therefore, the MiniPCI socket is well-suited for use as a connection interface between the TV module and external TV signals. The present invention utilizes the MiniPCI socket to position a TV module in order to achieve the function of playing the TV programs on the laptop. In this embodiment, the multiple-deck MiniPCI socket 10 is a double-deck MiniPCI socket. And each of the MiniPCI sockets of the multiple-deck MiniPCI socket 10 comprises a plurality of plugs in order to plug pins of a device, which conforms to the MiniPCI standard. The two MiniPCI sockets 14, 15 are arranged in decks of different heights corresponding to the motherboard. Therefore, although a plurality of peripheral interface cards are plugged in the MiniPCI sockets, the occupied area of the motherboard by the interface cards is not increased. The multiple-deck MiniPCI socket 10 comprises a plurality of conductive slices, which are arranged in parallel. Each conductive slice is electrically connected to the motherboard, and comprises two plugs, wherein the two plugs are located on two corresponding positions of different decks. This means that when the two peripheral interface cards are plugged in the multiple-deck MiniPCI socket 10, the two peripheral interface cards can transfer electrical signals to the motherboard through every two corresponding pins corresponding to each conductive slice. The above-mentioned conductive slices are separated by insulators. Furthermore, the number of conductive slices of the multiple-deck MiniPCI socket 10 is determined according to the number of pins of the aforementioned peripheral interface cards. Now taking a multiple-deck MiniPCI socket having 128 parallel conductive slices for example, the conductive slices are illustrated as follows:

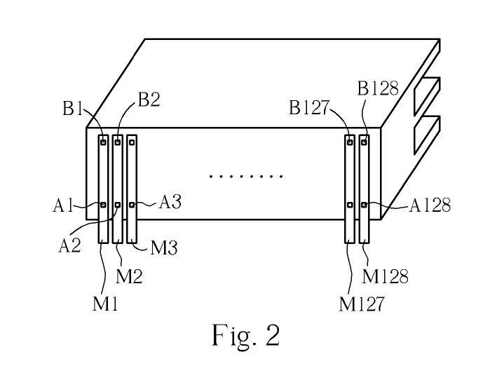

Please refer to FIG. 2, which is a sectional diagram of the multiple-deck MiniPCI socket shown in FIG. 1 through the line 2-2′. As shown in FIG. 2, the first MiniPCI socket (the bottom deck) 14 has 128 plugs, A1-A128. In addition, the second MiniPCI socket (the top deck) 15 also has 128 plugs, B1-B128. Here, please note that 128 plugs of different decks correspond to each other. That is, A1 corresponds to B1, A2 corresponds to B2, . . . , and A128 corresponds to B128. FIG. 2 also shows 128 parallel conductive slices M1, M2, M3, . . . , M128. The conductive slice M1 establishes the electrical connection between the motherboard and a pin of a peripheral interface card, which is plugged in the bottom deck plug A1, and establishes the electrical connection between the motherboard and a pin of another peripheral interface card, which is plugged in the corresponding top deck plug B1. Therefore, the two MiniPCI sockets 14, 15 utilize the conductive slices M1-M128 to establish the electrical connection between the motherboard and the peripheral interface cards. Please note that the arrangement of the conductive slices in this embodiment is only for illustration, and is not a limitation. As mentioned above, although the multiple-deck MiniPCI socket 10 has an additional MiniPCI socket, the occupied area is not increased. This structure of multiple-deck MiniPCI socket makes it possible to use the wireless LAN module and the TV module at the same time.

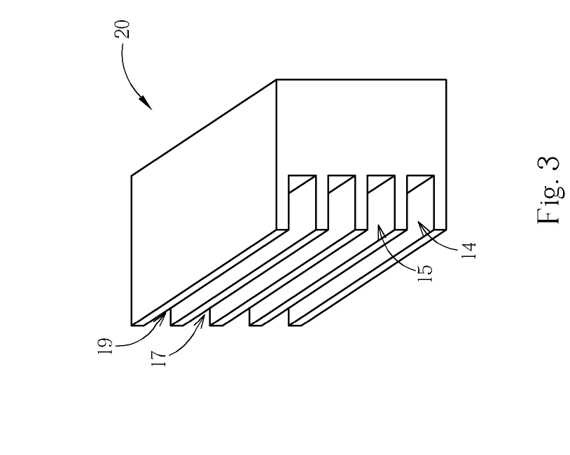

Please refer to FIG. 3, which is a diagram of a multiple-deck MiniPCI socket of another embodiment according to the present invention. In the embodiment shown in FIG. 3, the multiple-deck MiniPCI socket 20 is a 4-deck MiniPCI socket, where each MiniPCI socket of the multiple-deck MiniPCI socket 20 comprises a plurality of plugs. Therefore, although many interface cards can be plugged in the above-mentioned MiniPCI sockets, the occupied area of the motherboard is not increased due to the interface cards. The multiple-deck MiniPCI socket 20 comprises a plurality of conductive slices (not shown in FIG. 3), which are arranged in parallel. Each conductive slice is electrically connected to the motherboard, and comprises 4 plugs, wherein the 4 plugs are located on 4 corresponding positions of different decks. This means that when the 4 peripheral interface cards are plugged in the multiple-deck MiniPCI socket 20, the 4 peripheral interface cards can transfer electrical signals to the motherboard through every 4 corresponding pins corresponding to each conductive slice. The above-mentioned conductive slices are separated by insulators. Furthermore, the number of conductive slices of the multiple-deck MiniPCI socket 20 is determined according to the number of pins of the aforementioned peripheral interface cards. In above-mentioned two embodiments in FIG. 1 and FIG. 3, the number of MiniPCI sockets is determined according to the number of devices of the laptop. That is, if each deck of the multiple-deck MiniPCI socket has only one MiniPCI socket, more interface cards (such as the aforementioned WLAN module and TV module) need more decks of the MiniPCI sockets (not shown). Furthermore, in the embodiment of FIG. 3, the multiple-deck MiniPCI socket 20 is a 4-deck MiniPCI socket. Comparing the 4-deck MiniPCI socket with the multiple-deck MiniPCI socket 10, the only difference between them is the number of plugs of each conductive slice. That is, each conductive slice of the multiple-deck MiniPCI socket 20 has 4 plugs, which are located on 4 corresponding positions of different decks, and each conductive slice of the multiple-deck MiniPCI socket 10 has only 2 plugs, which are located on 2 corresponding positions of different decks. Please note that in these embodiments, pins of the interface cards are plugged in the plugs of the multiple-deck MiniPCI socket 10, 20. In fact, the plugs of the interface cards could also be plugged in the pins of the multiple-deck MiniPCI socket 10, 20. Furthermore, each conductive slice can be designed to have no plugs. That is, the conductive slice only needs to have a plurality of contact windows in order to make electrical contact. The above-mentioned changes all belong to the spirit of the present invention.

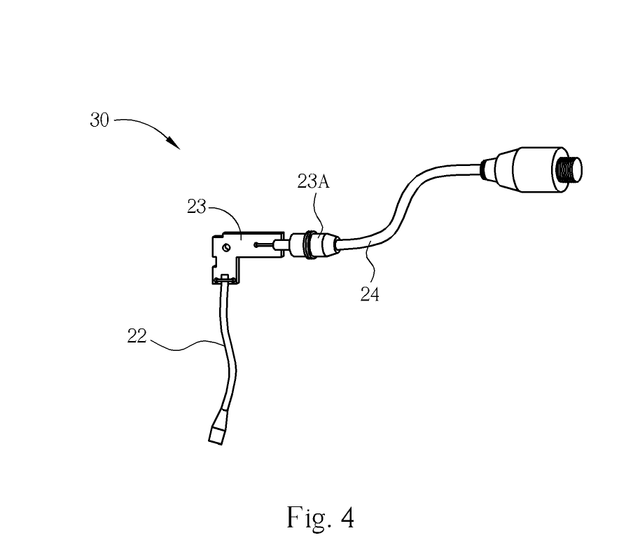

Please refer to FIG. 4, which is a diagram of a TV signal receiving interface 30 of an embodiment according to the present invention. The TV signal receiving interface 30 comprises an external cable 24, a high-voltage blocker 23, and an internal cable 22 (the integration of the high-voltage blocker 23 and the internal cable 22 can be called an internal transformer, in other words, the internal transformer comprises the high-voltage blocker 23 and the internal cable 22). The external cable 24 is electrically connected to a TV cable (not shown) to receive TV signals from the TV cable. The high-voltage blocker 23 is respectively electrically connected to the external cable 24 and the internal cable 22 for receiving TV signals from the external cable 24 and blocking or absorbing high voltage signals of the received TV signals, and then the high-voltage blocker 23 transfers the filtered TV signals to the internal cable 22.

In the embodiment of FIG. 4, the TV signals received by the TV cable can be wireless TV signals from an antenna (here, the antenna is electrically connected to the TV cable to transfer the received TV signals to the TV cable), or cable TV signals from a cable TV business owner. Because the TV cable is normally a coaxial cable and its corresponding connector is bigger than a normal connector (for example, the RJ-45 connector), if the TV cable is directly connected to the laptop, the laptop cannot be designed with a thin size. Therefore, the external cable 24 is mainly used to electrically connect the TV cable to the laptop. The two ends of the external cable 24 have different diameters, wherein the bigger end is connected to the TV cable, and the other end is connected to the high-voltage blocker 23 of the laptop. In this embodiment, the TV cable is external to the laptop, and the high-voltage blocker is inside the laptop. In order to easily connect the TV cable to the high-voltage blocker 23 of the laptop, the high-voltage blocker has a connector 23a for connecting to the smaller end of the external cable 24 (of course, because the connector 23a is only used for electrical connection between the high-voltage blocker 23 and the external cable 24, if other connection methods are used, the connector 23a can also be omitted).

The high-voltage blocker 23 is used to block an impulse or electrical surge, which can be caused by lightening. Because an antenna is often used at the top of a house or a car and the antenna is conductive, the antenna may be struck by lightening, which is a very high voltage signal. If the high-voltage blocker 23 is not used and the antenna is struck by lightening, the high voltage signal is transferred through the TV cable, the external cable 24, and the internal cable 22 into the laptop. This may cause major damage to many devices of the laptop (in a normal computer or laptop, a device can endure only 3.3 V, that is, if a signal more than 3.3 V is received, this can cause damage to the device). In order to prevent from this problem, the high-voltage blocker 23 is used to efficiently block or absorb high voltage signals. In this embodiment, the high-voltage blocker 23 comprises a diode. It is well-known that the diode can block high voltages. Therefore, the high-voltage blocker 23 utilizes the characteristic of the diode to achieve the function of blocking high voltage signals, and grounds the high voltage signals to absorb the lightening (not shown). In the aforementioned embodiment, although the present invention utilizes the external cable 24, the external cable 24 can be omitted according to design demands.

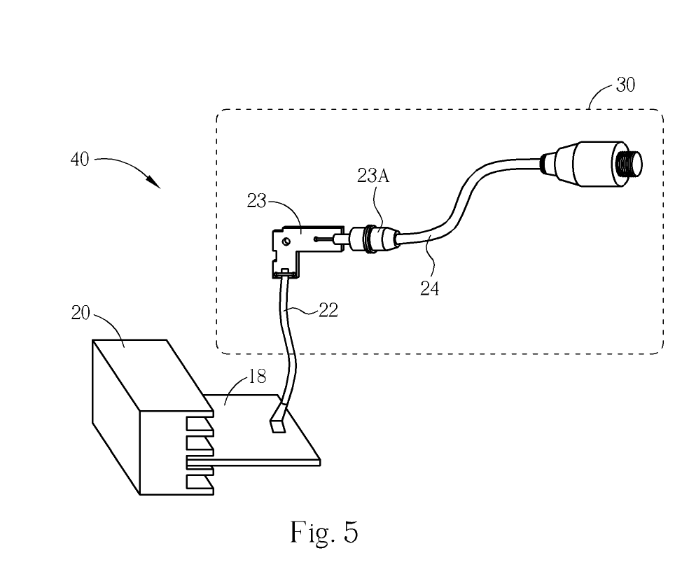

Please refer to FIG. 5, which is a diagram of a TV signal processing module 40 of an embodiment according to the present invention. The TV signal processing module 40 comprises a TV signal receiving interface 30, a TV module 18, and a multiple-deck MiniPCI socket 20, wherein the TV signal receiving interface 30 comprises an external cable 24, a high-voltage blocker 23, and an internal cable 22. In the embodiment of FIG. 5, the multiple-deck MiniPCI socket 20 is a 4-deck MiniPCI socket, wherein each deck has a MiniPCI socket. Each MiniPCI socket is used for plugging in a MiniPCI interface card (such as the TV module 18 or aforementioned WLAN module). In this embodiment, the TV module 18 can be plugged in each of the MiniPCI sockets, and 4 MiniPCI sockets are stacked on the motherboard. Because the multiple-deck MiniPCI socket 20 is illustrated above, it is omitted here. In this embodiment, one end of the internal cable 22 is electrically connected to the TV module 18, and since connection relationships between other devices have been illustrated above, they are omitted here, also.

The operation of the embodiment of FIG. 5 is illustrated as follows:

First, the external cable 24 transfers received TV signals to the high-voltage blocker 23. Second, the high-voltage blocker 23 blocks or absorbs the high voltage signals of the TV signals and transfer the filtered TV signals to the internal cable 22. Third, the TV module 18 transforms the TV signals from the internal cable 22 into signals conforming to the MiniPCI socket. At last, the signals conforming to the MiniPCI socket are transferred to the prior art south-bridge chip through the motherboard in order to perform further processing (for example, to display TV images). Because the TV module 18 and the south-bridge chip are well-known by those skilled in the art, they are omitted here for simplification.

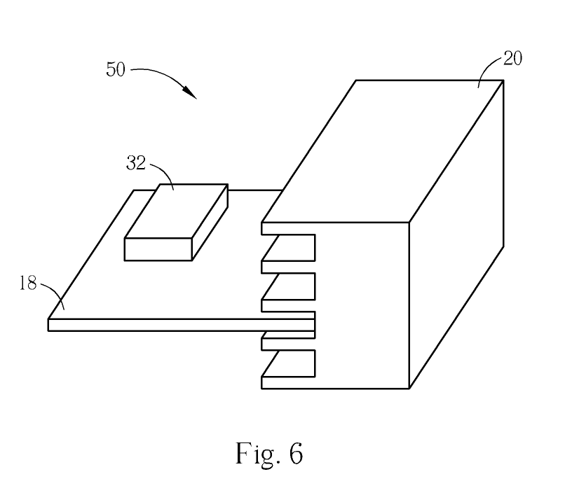

Please refer to FIG. 6, which is a diagram of a TV signal processing module 50 of another embodiment according to the present invention. The TV signal processing module 50 comprises a multiple-deck MiniPCI socket 20, a TV module 18, and a TV signal receiving interface 32, wherein the TV signal receiving interface 32 is a wireless receiving module. The TV signal receiving interface 32 is connected to the TV module 18 for replacing the TV signal receiving interface 30 shown in FIG. 5, receiving wireless TV signals, and transferring the received wireless TV signals to the TV module 18. And the TV module 18 can be plugged in one of the sockets of the multiple-deck MiniPCI socket 20 for transforming the wireless TV signals from the TV signal receiving interface 32 into signals conforming to the MiniPCI socket. Here, the multiple-deck MiniPCI socket 20 is connected to the motherboard (the connection relationships are illustrated in the above embodiments, so they are omitted) for transferring the signals conforming to the MiniPCI socket to the prior art south-bridge chip through the motherboard to perform further processing.

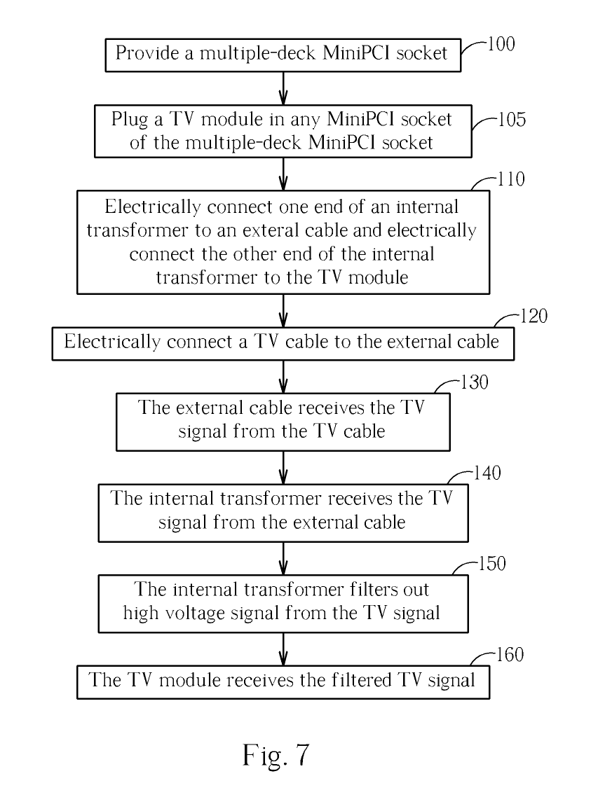

Please refer to FIG. 7, which is a diagram of a method for transferring a TV signal to a TV module of the multiple-deck MiniPCI socket of an embodiment according to the present invention. It comprises the following steps:

Step 100: Provide the multiple-deck MiniPCI socket; the structure of the multiple-deck MiniPCI socket is taught above;

Step 105: Plug a TV module into a MiniPCI socket of the multiple-deck MiniPCI socket;
Step 110: Electrically connect one end of an internal transformer to an external cable, and electrically connect the other end of the internal transformer to the TV module;
Step 120: Electrically connect a TV cable to the external cable;
Step 130: Utilize the external cable to receive the TV signal from the TV cable;
Step 140: Utilize the internal transformer to receive the TV signal from the external cable;
Step 150: Utilize the internal transformer to filter out high voltage signals from the TV signal; wherein the internal transformer comprises a high-voltage blocker to block or absorb the high voltage signals, and the internal transformer utilizes a diode to block the high voltage signals or grounds the high voltage signals to absorb them; and
Step 160: Utilize the TV module to receive the filtered TV signal.

In the prior art, in order to integrate the TV module in the laptop, the floppy-disk module or DVD playing module must be removed to make room for the TV module. However, although this can achieve the function of watching TV in the laptop, this also causes inconvenience to users. Users cannot simultaneously utilize the TV module to watch TV and utilize the DVD playing module to record TV programs. The prior art computer producers disclose an external TV module, which is electrically connected to the laptop through a USB 2.0 port. Because the TV module is not built-in the laptop, users have to carry another TV module, which causes inconvenience and the trouble of connecting the TV module and other devices to the laptop. So the external TV module does not conform to the demands of modern integrated laptops.

In contrast to the prior art, the present invention utilizes the above-mentioned multiple-deck MiniPCI socket and protects the socket from high voltage signals to solve the problems of the prior art. This also enables users to watch TV on the laptop and simultaneously record TV programs on writable optical media.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multiple-deck MiniPCI socket for positioning at least one MiniPCI card, the multipledeck MiniPCI socket comprising:
a plurality of MiniPCI sockets arranged in decks, wherein each socket comprises a plurality of plugs or pins.

2. A TV signal processing module comprising:
a TV module for processing TV signals;
an internal transformer electrically connected to the TV module for transferring the TV signals to the TV module, the internal transformer comprising a high-voltage blocker for preventing a high-voltage from entering the TV module; and
an external cable for transferring the TV signals from a TV cable to the internal transformer;
wherein one end of the external cable is electrically connected to the TV cable and the other end of the external cable is electrically connected to the internal transformer.

3. The TV signal processing module of claim 2, wherein the high-voltage blocker comprises a diode for blocking a high voltage signal.

4. The TV signal processing module of claim 2, wherein the high-voltage blocker is grounded.

5. The TV signal processing module of claim 2 further comprising:
a multiple-deck MiniPCI socket for positioning the TV module, the multiple-deck MiniPCI socket comprising:
a plurality of MiniPCI sockets arranged in decks, each socket comprising a plurality of plugs or pins, wherein the TV module is plugged in one of the MiniPCI sockets of the multiple-deck MiniPCI socket.

6. A TV signal processing module comprising:
a multiple-deck MiniPCI socket comprising:
a plurality of MiniPCI sockets arranged in decks, each socket comprising a plurality of plugs or pins;
a TV module plug in one of the MiniPCI sockets of the multiple-deck MiniPCI socket for processing a TV signal; and
a wireless receiving module electrically connected to the TV module for receiving the TV signal wirelessly and transferring the TV signal to the TV module.

7. A method for transferring a TV signal to a TV module, the method comprising:
providing an external cable;
electrically connecting one end of an internal transformer to the external cable;
electrically connecting the other end of the internal transformer to the TV module;
electrically connecting a TV cable to the external cable;
utilizing the external cable to receive the TV signal from the TV cable;
utilizing the internal transformer to receive the TV signal from the external cable;
utilizing the internal transformer to filter out high voltage signals from the TV signal; and
utilizing the TV module to receive the filtered high voltage TV signals.

8. The method of claim 7, wherein the step of utilizing the internal transformer to filter out the high voltage signals from the TV signal comprises:
utilizing a diode to block the high voltage signals.

9. The method of claim 7, wherein the step of utilizing the internal transformer to filter out the high voltage signals from the TV signal comprises:
filtering out the high voltage signals through grounding.
